(19) United States
(12) Patent Application Publication
(10) Pub. No.: US 2026/0085495 A1
(43) Pub. Date: Mar. 26, 2026

(54) WORKING MACHINE

(71) Applicant: KUBOTA CORPORATION, Osaka (JP)

(72) Inventor: Hiroshi HORII, Osaka (JP)

(73) Assignee: KUBOTA CORPORATION, Osaka (JP)

(21) Appl. No.: 19/406,112

(22) Filed: Dec. 2, 2025

Related U.S. Application Data
(63) Continuation of application No. PCT/JP2024/029342, filed on Aug. 19, 2024.

(30) Foreign Application Priority Data
Aug. 25, 2023 (JP) 2023-137452

(51) Int. Cl. E02F 9/22; E02F 9/08; F15B 1/26; F15B 13/06

(52) U.S. Cl. CPC E02F 9/2203; E02F 9/0883; E02F 9/2275; F15B 1/26; F15B 13/06; E02F 9/2285; E02F 9/2292; E02F 9/2296

(57) ABSTRACT

A working machine includes first and second outlet ports to allow hydraulic fluid to flow out, first hydraulic actuators supplied with hydraulic fluid from the first outlet port, second hydraulic actuators supplied with hydraulic fluid from the second outlet port, a load pressure selection valve to receive load pressures and output a highest load pressure which is higher of the load pressures on the first and second hydraulic actuators, a regulator to receive the highest load pressure and control discharge rates of hydraulic fluid from the outlet ports according to the highest load pressure, a passage throttle in a load pressure transmission passage between the regulator and the load pressure selection valve, and a bleed path to allow hydraulic fluid in a segment passage of the load pressure transmission passage between the load pressure selection valve and the passage throttle to partially escape to a destination other than the regulator.

### CROSS REFERENCE TO RELATED APPLICATIONS

This application is a continuation application of International Application No. PCT/JP2024/029342, filed on Aug. 19, 2024, which claims the benefit of priority to Japanese Patent Application No. 2023-137452, filed on Aug. 25, 2023. The entire contents of each of these applications are hereby incorporated herein by reference.

### BACKGROUND OF THE INVENTION

### 1. Field of the Invention The present invention relates to working machines such as backhoes.

### 2. Description of the Related Art A working machine disclosed in Japanese U.S. Pat. No. 5,480,847 is known.

The working machine disclosed in Japanese U.S. Pat. No. 5,480,847 includes a first outlet port and a second outlet port to allow hydraulic fluid to flow out therefrom, and a load pressure selection valve to receive input of a load pressure on a plurality of first hydraulic actuators to be supplied with the hydraulic fluid from the first outlet port and a load pressure on a plurality of second hydraulic actuators to be supplied with the hydraulic fluid from the second outlet port, and output the highest load pressure which is the higher one of the load pressure on the plurality of first hydraulic actuators and the load pressure on the plurality of second hydraulic actuators.

The highest load pressure output from the load pressure selection valve is input into a regulator, and the regulator controls the discharge rate of the hydraulic fluid from the first outlet port and the discharge rate of the hydraulic fluid from the second outlet port according to the input highest load pressure. A passage provided between the load pressure selection valve and the regulator is provided with a throttle, and the load pressure output from the load pressure selection valve is transmitted to the regulator via the throttle.

### SUMMARY OF THE INVENTION

The above working machine is configured such that the load pressure on the first hydraulic actuators and the load pressure on the second hydraulic actuators are input to the load pressure selection valve, and the highest load pressure which is the higher one of the load pressure on the first hydraulic actuators and the load pressure on the second hydraulic actuators is output from the load pressure selection valve, and the highest load pressure is transmitted to the regulator via the throttle. Therefore, when the viscosity of the hydraulic fluid increases at low temperature, because of the resistance in the load pressure selection valve and the throttle, the response may be delayed.

Example embodiments of the present invention make it possible to improve responsiveness at low temperature in regard to a working machine including a first outlet port and a second outlet port to allow hydraulic fluid to flow out therefrom, a load pressure selection valve to output the highest load pressure which is the higher one of the load pressure on a plurality of first hydraulic actuators to be supplied with hydraulic fluid from the first outlet port and the load pressure on a plurality of second hydraulic actuators to be supplied with hydraulic fluid from the second outlet port, a regulator to control the discharge rate of the hydraulic fluid from the first outlet port and the discharge rate of the hydraulic fluid from the second outlet port according to the highest load pressure, and a passage throttle provided in a load pressure transmission passage provided between the regulator and the load pressure selection valve.

A working machine according to an example embodiment of the present invention includes a first outlet port and a second outlet port to allow hydraulic fluid to flow out therefrom, a plurality of first hydraulic actuators to be supplied with hydraulic fluid from the first outlet port, a plurality of second hydraulic actuators to be supplied with hydraulic fluid from the second outlet port, a load pressure selection valve to receive input of a load pressure on the plurality of first hydraulic actuators and a load pressure on the plurality of second hydraulic actuators, and output a highest load pressure which is a higher one of the load pressure on the plurality of first hydraulic actuators and the load pressure on the plurality of second hydraulic actuators, a regulator to receive input of the highest load pressure output from the load pressure selection valve, and control a discharge rate of the hydraulic fluid from the first outlet port and a discharge rate of the hydraulic fluid from the second outlet port according to the input highest load pressure, a passage throttle provided in a load pressure transmission passage provided between the regulator and the load pressure selection valve, and a bleed path to allow a portion of the hydraulic fluid in a segment passage to escape to a destination other than the regulator, the segment passage being a portion of the load pressure transmission passage that is located between the load pressure selection valve and the passage throttle.

The working machine may further include a hydraulic fluid tank to store the hydraulic fluid. The bleed path may include a bleed passage including a first end connected to the segment passage and a second end in fluid communication with the hydraulic fluid tank, and a bleed throttle provided in the bleed passage.

The first end of the bleed passage may be connected to a portion of the segment passage that is in a vicinity of the passage throttle.

The working machine may further include a hydraulic fluid tank to store the hydraulic fluid, a first line connected to one of input ports of the load pressure selection valve, a second line connected to another of the input ports of the load pressure selection valve, a plurality of first load transmission fluid passages which are connected to the first line and which correspond to the respective plurality of first hydraulic actuators to transmit respective loads on the respective plurality of first hydraulic actuators, and, a plurality of second load transmission fluid passages which are connected to the second line and which correspond to the respective plurality of second hydraulic actuators, to transmit respective loads on the respective plurality of second hydraulic actuators, a first release path to allow a portion of the hydraulic fluid in the first line to escape to the hydraulic fluid tank at a location upstream of the load pressure selection valve, and a second release path to allow a portion of the hydraulic fluid in the second line to escape to the hydraulic fluid tank at another location upstream of the load pressure selection valve.

The working machine may further include a plurality of first control valves, which correspond to the respective plurality of first hydraulic actuators, to control a flow of the hydraulic fluid with respect to the respective plurality of first hydraulic actuators, a plurality of second control valves, which correspond to the respective plurality of second hydraulic actuators, to control a flow of the hydraulic fluid with respect to the respective plurality of second hydraulic actuators, and a control valve assembly including the plurality of first control valves, the plurality of second control valves, the load pressure selection valve, and the passage throttle. A portion of the load pressure transmission passage that is between the control valve assembly and the regulator may include a hydraulic hose.

The bleed throttle may be directly or indirectly attached to the control valve assembly.

The bleed passage may be included in the control valve assembly. The first end of the bleed passage may be connected to the segment passage. The second end of the bleed passage may be in fluid communication with the hydraulic fluid tank via a drain fluid passage provided in the control valve assembly.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a general side view of a backhoe.

FIG. 2 is a block diagram schematically illustrating a hydraulic system.

FIG. 3 is a hydraulic circuit diagram schematically illustrating a hydraulic system.

FIG. 4 is a hydraulic circuit diagram of an inlet block.

FIG. 5 is a hydraulic circuit diagram of a right travel control valve, a first dozer control valve, a swivel control valve, an arm control valve, a swing control valve, and a first SP control valve.

FIG. 6 is a hydraulic circuit diagram of a left travel control valve, a second dozer control valve, a boom control valve, a bucket control valve, and a second SP control valve.

FIG. 7 is a hydraulic circuit diagram of a traveling system.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

The following discusses example embodiments of the present invention with reference to drawings.

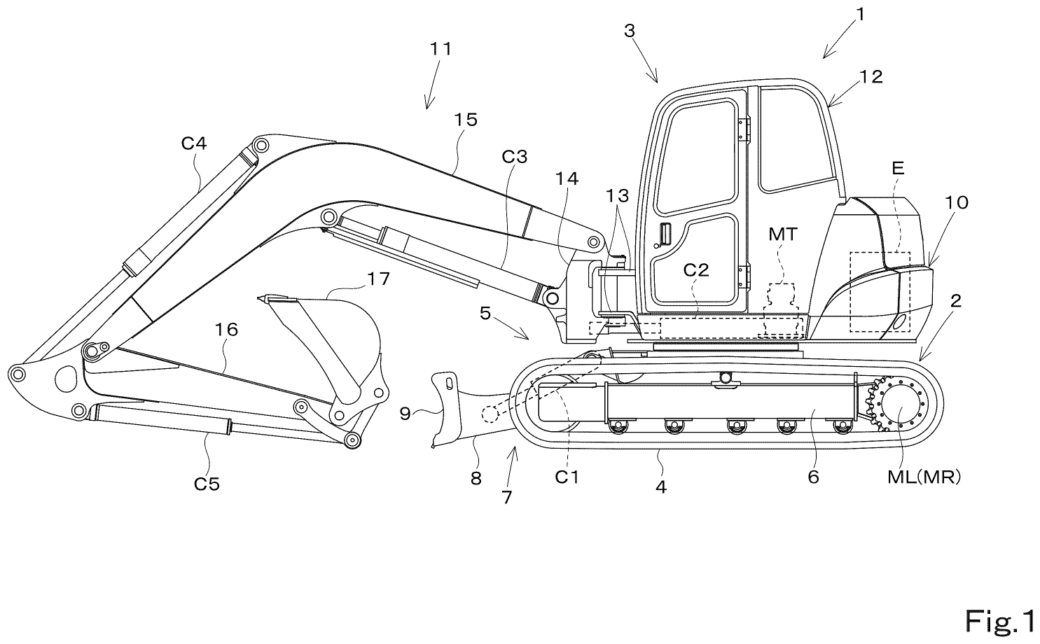

FIG. 1 is a schematic side view illustrating a general configuration of a working machine 1 according to the present example embodiment. In the present example embodiment, a backhoe, which is a swiveling working machine, is illustrated as an example of the working machine 1.

The backhoe 1 mainly includes a travel body 2 provided at a lower portion of the backhoe 1 and a swivel body 3 which is provided at an upper portion of the backhoe 1 and which is provided, on the travel body 2, such that the swivel body 3 is swivelable (fully swivelable) about a swivel axis extending in the up-down direction.

The travel body 2 includes crawler traveling devices 5 on the right and left sides of a track frame 6. The traveling devices 5 are configured to cause respective endless crawler belts 4 to rotates in a circumferential direction by respective travel motors ML, MR including hydraulic motors (hydraulic actuators).

A dozer device 7 is provided at a front portion of the track frame 6. The dozer device 7 includes a blade 9 provided at a front end portion of a support arm 8 pivotally connected at its rear end to the track frame 6 and swingable in the up-down direction. The support arm 8 is driven to move up or down by the extension or retraction of a dozer cylinder C1 including a hydraulic cylinder (hydraulic actuator).

The swivel body 3 includes a swivel base 10 provided on the track frame 6 such that the swivel base 10 is swivelable about the swivel axis, a front working device 11 provided at a front portion of the swivel base 10, and a cabin 12 provided on the swivel base 10.

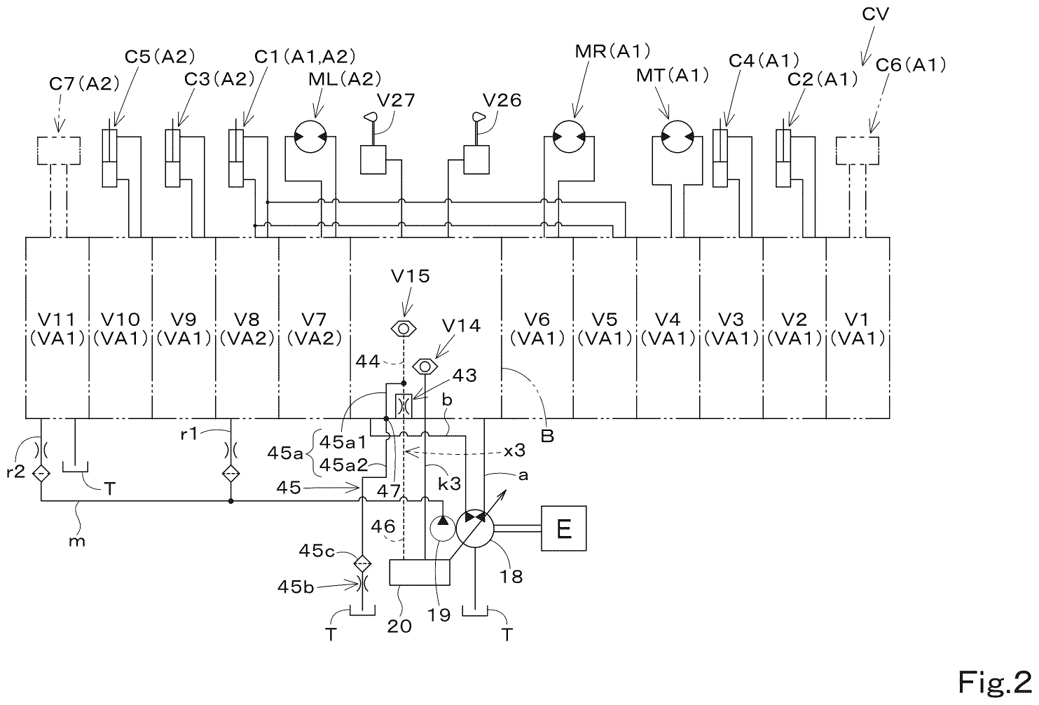

The swivel base 10 is provided with an engine E, a radiator, a fuel tank, a hydraulic fluid tank T (see FIG. 2, etc.), a battery and/or the like. The hydraulic fluid tank T is configured to store hydraulic fluid. The swivel base 10 is driven to swivel by a swivel motor MT including a hydraulic motor (hydraulic actuator).

A support bracket 13 is provided at the front portion of the swivel base 10 such that the support bracket 13 projects forward from the swivel base 10. A swing bracket 14 is supported by the support bracket 13 to be swingable left and right about an axis extending in the up-down direction. The swing bracket 14 is driven to swing by a swing cylinder C2 including a hydraulic cylinder (hydraulic actuator) to swing left and right.

The front working device 11 mainly includes a boom 15 configured such that a proximal portion of the boom 15 is pivotally connected to an upper portion of the swing bracket 14 to be rotatable about an axis extending in a machine body width direction and to be swingable in the up-down direction, an arm 16 pivotally connected to a distal portion of the boom 15 to be rotatable about an axis extending in the machine body width direction and to be swingable, and a bucket 17 (working tool) pivotally connected to a distal portion of the arm 16 to be rotatable about an axis extending in the machine body width direction and to be swingable.

The boom 15 is driven to swing by a boom cylinder C3 provided between the boom 15 and the swing bracket 14. The arm 16 is driven to swing by an arm cylinder C4 provided between the arm 16 and the boom 15. The bucket 17 is driven to swing by a bucket cylinder C5 (working tool cylinder) provided between the bucket 17 and the arm 16.

The boom cylinder C3, the arm cylinder C4, and the bucket cylinder C5 each include a hydraulic cylinder (hydraulic actuator).

Instead of or in addition to the bucket 17, the backhoe 1 of the present example embodiment is configured to have attached thereto any of one or more other working tools (hydraulic attachments) to be driven by hydraulic actuator(s). Examples of the other working tools include a hydraulic breaker, a hydraulic crusher, an angle bloom, an earth auger, a pallet fork, a sweeper, a mower, and a snow blower.

As shown in FIGS. 2, 5 and 6, in the present example embodiment, one or two hydraulic actuators (a hydraulic actuator C6 and/or a hydraulic actuator C7) included in the hydraulic attachment can be controlled (operated).

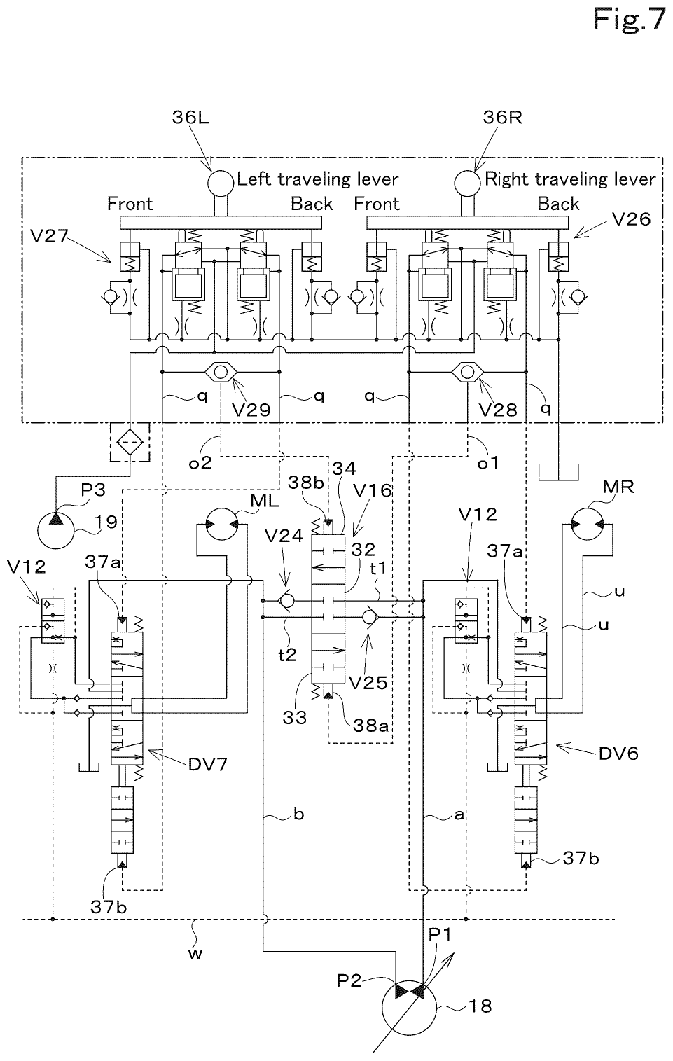

The following discusses a hydraulic system to actuate the hydraulic actuators ML, MR, MT, C1 to C7 provided in the backhoe 1 with reference to FIGS. 2 to 7.

The hydraulic system of the backhoe 1, as shown in FIG. 2, includes a control valve assembly CV to control the hydraulic actuators ML, MR, MT, C1 to C7, a main pump 18 to supply hydraulic fluid to actuate the hydraulic actuators ML, MR, MT, C1 to C7, and a sub-pump 19 to supply signal pressure fluid such as pilot pressure and detection signal(s). The main pump 18 and the sub-pump 19 are driven by the engine (prime mover) E provided on the swivel base 10. It is noted that an electric motor may be included instead of the engine E.

The main pump 18 is a swash-plate variable displacement axial pump having a function of an equal-flow-rate double pump to suck the hydraulic fluid from the hydraulic fluid tank T and deliver equal amounts of the hydraulic fluid (pressure fluid) through two independent outlet ports P1, P2. Specifically, the main pump 18 is a split flow hydraulic pump including a mechanism to deliver the hydraulic fluid (pressure fluid) from a single piston-cylinder barrel kit to outlet grooves in inner and outer portions of the valve plate alternately.

One of the outlet ports (outlet port P1) to allow the hydraulic fluid to flow out from the main pump 18 is referred to as a first outlet port P1, and the other of the outlet ports (outlet port P2) is referred to as a second outlet port P2.

The hydraulic system includes a regulator 20 to control the tilt angle of the swash plate of the main pump 18.

Note that the main pump 18 may include two swash-plate variable displacement hydraulic pumps. Specifically, the main pump 18 may include one swash-plate variable displacement hydraulic pump including a single outlet port (first outlet port P1) and one swash-plate variable displacement hydraulic pump including a single outlet port (second outlet port P2).

The sub-pump 19 is a fixed displacement gear pump to deliver the hydraulic fluid sucked from the hydraulic fluid tank T. A port to allow the hydraulic fluid (pressure fluid) to flow out from the sub-pump 19 is referred to as a third outlet port P3.

As shown in FIG. 2, the control valve assembly CV includes control valves V1 to V11 to control the hydraulic actuators ML, MR, MT, C1 to C7, and an inlet block B for intake of pressure fluid, which are collected and arranged in one direction.

The control valve assembly CV, in the present example embodiment, includes the following valves which are arranged in order (in the order from the right in FIG. 2) and connected to each other: a first SP control valve V1 to control the hydraulic actuator C6, a swing control valve V2 to control the swing cylinder C2, an arm control valve V3 to control the arm cylinder C4, a swivel control valve V4 to control the swivel motor MT, a first dozer control valve V5 to control the dozer cylinder C1, a right travel control valve V6 to control the travel motor MR for the right traveling device 5, the inlet block B for intake of the pressure fluid, a left travel control valve V7 to control the travel motor ML for the left traveling device 5, a second dozer control valve V8 to control the dozer cylinder C1, a boom control valve V9 to control the boom cylinder C3, a bucket control valve V10 to control the bucket cylinder C5, and a second SP control valve V11 to control the hydraulic actuator C7.

In the present example embodiment, the hydraulic actuator C6, the swing cylinder C2, the arm cylinder C4, the swivel motor MT, the dozer cylinder C1 and the travel motor MR correspond to a plurality of first hydraulic actuators A1 to be supplied with the hydraulic fluid from the first outlet port P1. The travel motor ML, the dozer cylinder C1, the boom cylinder C3, the bucket cylinder C5, and the hydraulic actuator C7 correspond to a plurality of second hydraulic actuators A2 to be supplied with the hydraulic fluid from the second outlet port P2.

Although the dozer cylinder C1 in the present example embodiment belongs to the first hydraulic actuator A1 and the second hydraulic actuator A2, it is noted that the dozer cylinder C1 corresponds to the first hydraulic actuator A1 in the case where the dozer cylinder C1 is controlled by the first dozer control valve V5 alone, and the dozer cylinder C1 corresponds to the second hydraulic actuator A2 in the case where the dozer cylinder C1 is controlled by the second dozer control valve V8 alone.

The first SP control valve V1, the swing control valve V2, the arm control valve V3, the swivel control valve V4, the first dozer control valve V5, and the right travel control valve V6 correspond to first control valves VA1 to control a flow of the hydraulic fluid with respect to the respective first hydraulic actuators A1. The left travel control valve V7, the second dozer control valve V8, the boom control valve V9, the bucket control valve V10, and the second SP control valve V11 correspond to second control valves VA2 to control a flow of the hydraulic fluid with respect to the respective second hydraulic actuators A2.

Thus, the first control valves VA1 are provided such that they correspond to the respective first hydraulic actuators A1, and the second control valves VA2 are provided such that they correspond to the respective second hydraulic actuators A2.

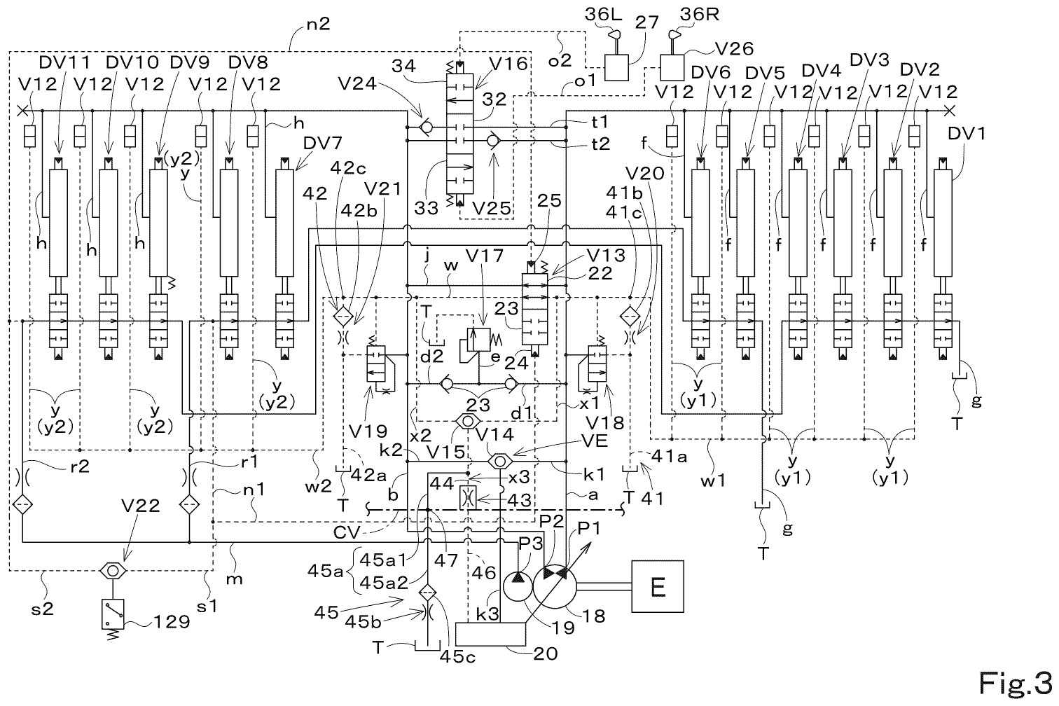

As shown in FIGS. 3 to 7, each of the control valves V1 to V11 contains, in the valve body thereof, a switching valve DV1 to DV11 and a pressure compensation valve V12.

Each direction switching valve DV1 to DV11 switches the direction of a flow of pressure fluid with respect to the corresponding hydraulic actuator ML, MR, MT, C1 to C7 that it controls. Each pressure compensation valve V12 is provided at a location downstream of the corresponding direction switching valve DV1 to DV11 in the direction of supply of pressure fluid and upstream of the corresponding hydraulic actuator ML, MR, MT, C1 to C7 to be controlled.

Each of the direction switching valves DV1 to DV11 of the control valves V1 to V11 is a direct-acting-spool switching valve and is a pilot-operated switching valve switched by pilot pressure.

Each of the direction switching valves DV1 to DV11 of the control valves V1 to V11 is configured such that the spool is moved in proportion to the operation amount of the manual operator to operate the corresponding direction switching valve DV1 to DV11, and that the corresponding hydraulic actuator ML, MR, MT, C1 to C7 is supplied with the pressure fluid in an amount proportional to the amount of movement of the spool (such that the speed of actuation of the hydraulic actuator ML, MR, MT, C1 to C7 to be operated is changeable in proportion to the operation amount of the corresponding manual operator).

The direction switching valve DV5 of the first dozer control valve V5 and the direction switching valve DV8 of the second dozer control valve V8 are actuated concurrently by a manual operator such as a single dozer lever or the like which is used to operate the dozer device 7.

The inlet block B contains a travel independent valve V13, a PPS signal shuttle valve V14, a PLS signal shuttle valve (also referred to as a load pressure selection valve) V15, a travel bypass valve V16, a relief valve V17, a first unloading valve V18, a second unloading valve V19, a first release path 41, a second release path 42, and a passage throttle 43.

The first outlet port P1 of the main pump 18 has connected thereto a first delivery passage a. The second outlet port P2 has connected thereto a second delivery passage b. The first delivery passage a and the second delivery passage b extend into the inlet block B.

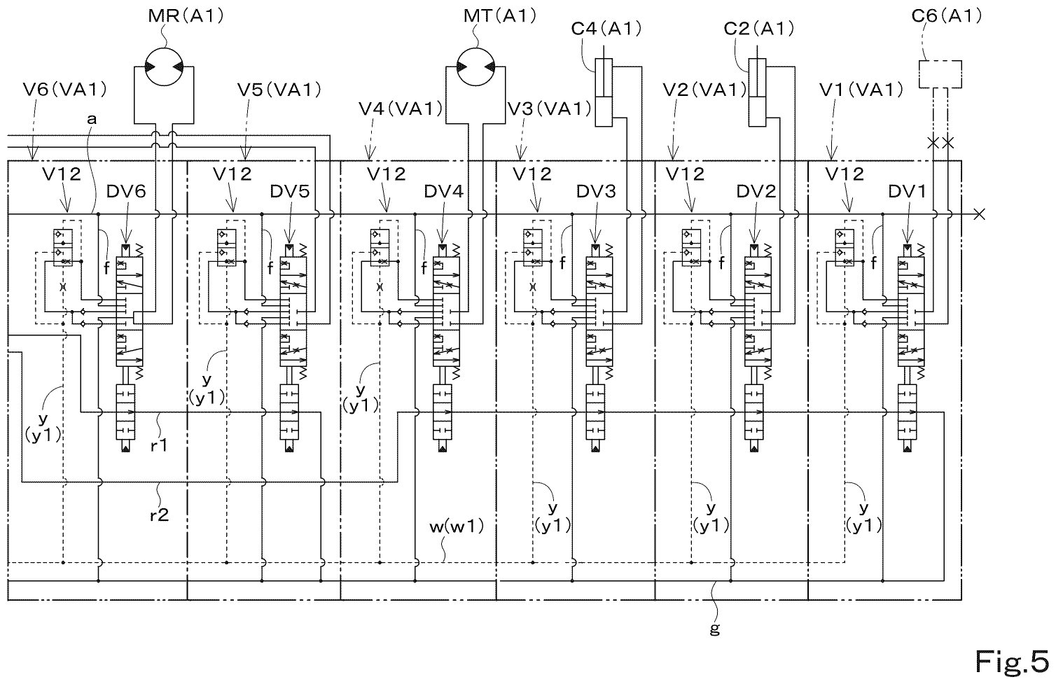

As shown in FIG. 5, the first delivery passage a extends from the inlet block B to the valve body of the first SP control valve V1 via the valve body of the right travel control valve V6, the valve body of the first dozer control valve V5, the valve body of the swivel control valve V4, the valve body of the arm control valve V3, the valve body of the swing control valve V2, and is closed at the terminal of the flow passage.

The hydraulic fluid (pressure fluid) can be supplied from the first delivery passage a to the switching valves DV6, DV5, DV4, DV3, DV2, DV1 of the right travel control valve V6, the first dozer control valve V5, the swivel control valve V4, the arm control valve V3, the swing control valve V2, and the first SP control valve V1 via respective pressure fluid branch passage f.

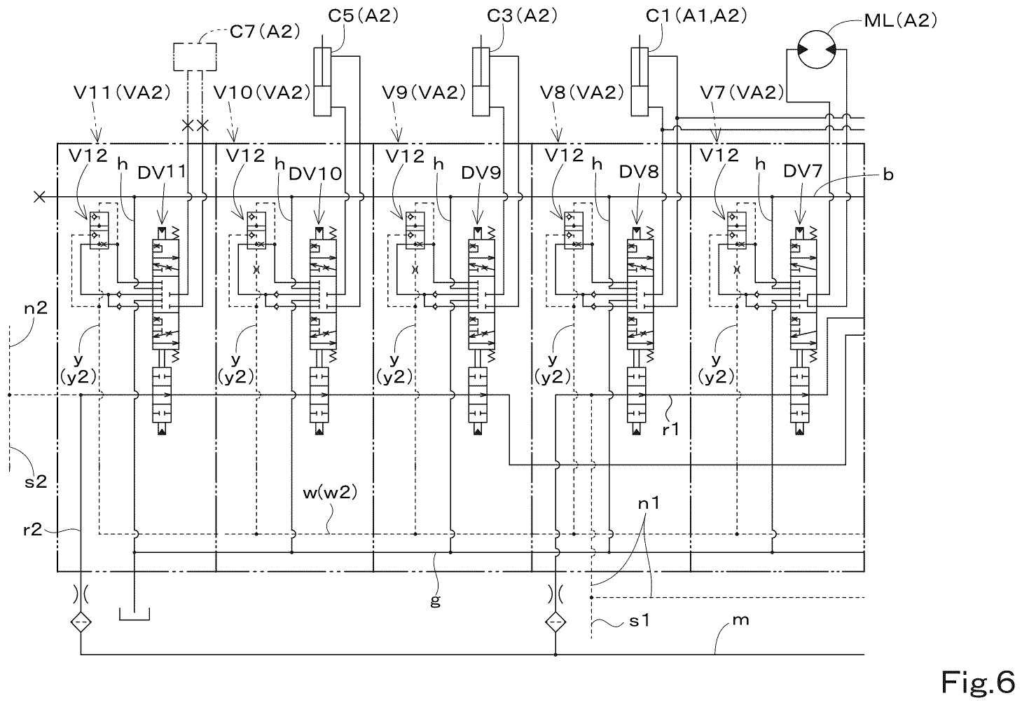

As shown in FIG. 6, the second delivery passage b extends from the inlet block B to the valve body of the second SP control valve V11 via the valve body of the left travel control valve V7, the valve body of the second dozer control valve V8, the valve body of the boom control valve V9, and the valve body of the bucket control valve V10, and is closed at the terminal of the flow passage.

The hydraulic fluid (pressure fluid) can be supplied from the second delivery passage b to the direction switching valves DV7, DV8, DV9, DV10, DV11 of the left travel control valve V7, the second dozer control valve V8, the boom control valve V9, the bucket control valve V10, and the second SP control valve V11 via respective pressure fluid branch passage h.

A drain fluid passage g extends from the valve body of the first SP control valve V1 to the valve body of the second control valve V11 via the inlet block B to drain the hydraulic fluid (pressure fluid) to the hydraulic fluid tank T.

As shown in FIG. 3, the first delivery passage a and the second delivery passage b are connected to each other, in the inlet block B, via a communication passage j extending through the travel independent valve V13.

The travel independent valve V13 is a direct-acting-spool switching valve and is a pilot-operated switching valve switched by the pilot pressure. The travel independent valve V13 can be switched between a merging position 22 allowing the pressure fluid to flow through the communication passage j and an independent supply position 23 blocking the hydraulic fluid from flowing through the communication passage j. The travel independent valve V13 is biased by one or more springs in a direction in which the travel independent valve V13 is switched to the merging position 22.

Therefore, when the travel independent valve V13 is switched to the merging position 22, the delivery fluid from the first outlet port P1 and the delivery fluid from the second outlet port P2 are merged. The merged delivery fluid can be supplied to the direction switching valves DV1 to DV11 of the control valves V1 to V11.

On the other hand, when the travel independent valve V13 is switched to the independent supply position 23, the delivery fluid from the first outlet port P1 can be supplied to the direction switching valves DV6, DV5 of the right travel control valve V6 and the first dozer control valve V5, and the delivery fluid from the second outlet port P2 can be supplied to the direction switching valves DV7, DV8 of the left travel control valve V7 and the second dozer control valve V8.

As shown in FIG. 3, the third outlet port P3 has connected thereto a third delivery passage m. The third delivery passage m has connected thereto the starting point of a first detection fluid passage r1 and the starting point of a second detection fluid passage r2.

The first detection fluid passage r1 extends from the third delivery passage m to the drain fluid passage g via the direction switching valve DV8 of the second dozer control valve V8, the direction switching valve DV7 of the left travel control valve V7, the direction switching valve DV6 of the right travel control valve V6, and the direction switching valve DV5 of the first dozer control valve V5.

The first detection fluid passage r1 has connected thereto the starting point of a first signal fluid passage n1 at a location upstream of the direction switching valve DV8 of the second dozer control valve V8. The ending point of the first signal fluid passage n1 is connected to one of pressure receivers (pressure receiver 24) of the travel independent valve V13.

The second detection fluid passage r2 extends from the third delivery passage m to the drain fluid passage g via the direction switching valve DV11 of the second SP control valve V11, the direction switching valve DV10 of the bucket control valve V10, the direction switching valve DV9 of the boom control valve V9, the direction switching valve DV4 of the swivel control valve V4, the direction switching valve DV3 of the arm control valve V3, the direction switching valve DV2 of the swing control valve V2, and the direction switching valve DV1 of the second SP control valve V1.

The second detection fluid passage r2 has connected thereto the start point of a second signal fluid passage n2 at a location upstream of the direction switching valve DV11 of the second SP control valve V11. The ending point of the second signal fluid passage n2 is connected to the other of the pressure receivers (pressure receiver 25) of the travel independent valve V13.

The travel independent valve V13 is, when the direction switching valves DV1 to DV11 of the control valves V1 to V11 are neutral, held in the merging position 22 by one or more springs.

When any of the direction switching valves DV6, DV7, DV5, DV8 of the right travel control valve V6, the left travel control valve V7, the first dozer control valve V5, and the second dozer control valve V8 is operated from the neutral position, a pressure occurs in the first detection fluid passage r1 and the travel independent valve V13 is switched from the merging position 22 to the independent supply position 23.

Therefore, the travel independent valve V13 is switched to the independent supply position 23 when travel only is performed, when only the dozer device 7 is driven, and when the dozer device 7 is used while travel is performed without driving the front working device 11, the swivel base 10, the swing bracket 14, the first SP control valve V1, or the second SP control valve V11.

In so doing, when any of the direction switching valves DV11, DV10, DV9, DV4, DV3, DV2, DV1 of the second SP control valve V11, the bucket control valve V10, the boom control valve V9, the swivel control valve V4, the arm control valve V3, the swing control valve V2, and the first SP control valve V1 is operated from the neutral position, a pressure occurs in the second detection fluid passage r2 and the travel independent valve V13 is switched from the independent supply position 23 to the merging position 22.

Therefore, when at least one of the left traveling device 5, the right traveling device 5 or the dozer device 7 and at least one of the boom 15, the arm 16, the bucket 17, the swivel base 10, the swing bracket 14, or a hydraulic attachment are operated concurrently, the travel independent valve V13 is switched to the merging position 22.

In the case where the direction switching valves DV1 to DV11 of the control valves V1 to V11 are neutral, when any of the direction switching valves DV11, DV10, DV9, DV4, DV3, DV2, DV1 of the second SP control valve V11, the bucket control valve V10, the boom control valve V9, the swivel control valve V4, the arm control valve V3, the swing control valve V2, and the first SP control valve V1 is operated from the neutral position, the travel independent valve V13 remains in the merging position 22.

The hydraulic system includes an automatic idling control system (hereinafter “AI system”) to automatically operate an accelerator of the engine E.

The AI system includes a pressure switch 129 connected to the first signal fluid passage n1 (first detection fluid passage r1) and the second signal fluid passage n2 (second detection fluid passage r2) via sensing fluid passages s1, s2 and a shuttle valve V22, an electric actuator to control a governor of the engine E, and a controller to control the electric actuator. The pressure switch 129 is connected to the controller.

In the AI system, since no pressure occurs in the first signal fluid passage n1 or the second signal fluid passage n2 when the direction switching valves DV1 to DV11 of the control valves V1 to V11 are neutral, the pressure switch 129 is not actuated by sensing pressure, and, in this state, the governor is automatically controlled by the electric actuator, etc. to bring the accelerator down to a predetermined idling position.

When at least one of the direction switching valves DV1 to DV11 of the control valves V1 to V11 is operated, a pressure occurs in the first signal fluid passage n1 or the second signal fluid passage n2, and the pressure switch 129 is actuated by sensing the pressure. Then, the controller transmits an instruction signal to the electric actuator, etc., and the governor is automatically controlled by the electric actuator, etc. to bring the accelerator up to a predetermined acceleration position.

In the present example embodiment, a relief valve V17 of the system is shared by the first delivery passage a and the second delivery passage b.

That is, the first delivery passage a has connected thereto the starting point of a first relief fluid passage d1 and the second delivery passage b has connected thereto the starting point of a second relief fluid passage d2. The ending point of the first relief fluid passage d1 and the end point of the second relief fluid passage d2 are connected to each other and the connected ending points of the first relief fluid passage d1 and the second relief fluid passage d2 have connected thereto a discharge fluid passage e fluidly communicating with the hydraulic fluid tank T. The relief valve V17 is provided between the discharge fluid passage e.

A check valve V23 is provided between the relief fluid passages d1, d2.

Relief valves may be provided with respect to the first delivery passage a and the second delivery passage b, respectively.

The hydraulic system uses a load sensing system.

The load sensing system of the present example embodiment includes the pressure compensation valves V12 provided in the respective control valves V1 to V11, the regulator 20 to control the swash plate of the main pump 18, the first unloading valve V18 and the second unloading valve V19, the PPS signal shuttle valve V14, and the PLS signal shuttle valve V15.

The load sensing system of the present example embodiment uses an after-orifice load sensing system in which each of the pressure compensation valves V12 is provided at a location downstream of a corresponding one of the direction switching valves DV1 to DV11 in the direction of fluid supply.

In the load sensing system, when two or more of the hydraulic actuators ML, MR, MT, C1 to C7 of the backhoe 1 are operated concurrently, the corresponding pressure compensation valves V12 function to adjust a load between the corresponding hydraulic actuators ML, MR, MT, C1 to C7 to generate a pressure loss, in one or more of the control valves V1 to V11 subjected to a lower load pressure, in an amount of the pressure difference between the lower load pressure and the highest load pressure, making it possible to flow (distribute) the hydraulic fluid at a flow rate corresponding to the operation amount of each of the spools of the direction switching valves DV1 to DV11 regardless of the amount of load.

The load sensing system controls the discharge rate (delivery rate) of the hydraulic fluid delivered by the main pump 18 (through the first outlet port P1 and the second outlet port P2) according to the load pressures on the hydraulic actuators ML, MR, MT, C1 to C7 of the backhoe 1 and causes the main pump 18 to emit the hydraulic power required for the load, making it possible to save power and improve operability.

In other words, the load pressure selection valve (PLS signal shuttle valve) V15 receives input of the load pressure on the first hydraulic actuators A1 and the load pressure on the second hydraulic actuators A2, and outputs the highest load pressure which is the higher one of the load pressure on the first hydraulic actuators A1 and the load pressure on the second hydraulic actuators A2. The regulator 20 receives input of the highest load pressure output from the load pressure selection valve V15, and controls the discharge rate of the hydraulic fluid from the first outlet port P1 and the discharge rate of the hydraulic fluid from the second outlet port P2 according to the input load pressure.

The following discusses the load sensing system of the present example embodiment in detail.

The load sensing system includes a PPS signal transmission circuit to transmit the delivery pressure of the main pump 18 as a PPS signal pressure to the regulator 20, and a PLS signal transmission circuit (load signal transmission circuit) to transmit the highest one of the load pressures on the operated control valves V1 to V11 as a PLS signal pressure (load signal pressure) to the regulator 20.

The PPS signal transmission circuit includes the PPS signal shuttle valve V14. One of the input ports (input port 26) of the PPS signal shuttle valve V14 is connected to the first delivery passage a via a first PPS input fluid passage k1, the other of the input ports (input port 27) of the PPS signal shuttle valve V14 is connected to the second delivery passage b via a second PPS input fluid passage k2, and an output port 28 of the PPS signal shuttle valve V14 is connected to the regulator 20 via a PPS output fluid passage k3.

Therefore, when the travel independent valve V13 is in the merging position 22, the first delivery passage a and the second delivery passage b of the main pump 18 are subjected to the same pressure, and the delivery pressure of the main pump 18 is transmitted from the open one of the input ports 26, 27 of the PPS signal shuttle valve V14 to the regulator 20.

When the travel independent valve V13 is in the independent supply position 23, (i) the higher one of the pressure in the first delivery passage a and the pressure in the second delivery passage b is transmitted to the regulator 20 via the PPS signal shuttle valve V14 or (ii) when the first delivery passage a and the second delivery passage b are subjected to the same pressure, the delivery pressure of the main pump 18 is transmitted from the open one of the input ports 26, 27 of the PPS signal shuttle valves V14 to the regulator 20.

The PLS signal transmission circuit includes a PLS signal transmission fluid passage w to transmit the load pressures on the control valves V1 to V11, and the PLS signal shuttle valve V15.

As shown in FIGS. 5 and 6, the PLS signal transmission fluid passage w extends from the valve body of the first SP control valve V1 through, in order, the valve body of the swing control valve V2, the valve body of the arm control valve V3, the valve body of the swivel control valve V4, the valve body of the first dozer control valve V5, the valve body of the right travel control valve V6, the inlet block B, the valve body of the left travel control valve V7, the valve body of the second dozer control valve V8, the valve body of the boom control valve V9, the valve body of the bucket control valve V10, and the valve body of the second SP control valve V11. The PLS signal transmission fluid passage w is connected, in the control valves V1 to V11, to the pressure compensation valves V12 via load transmission fluid passages y.

The PLS signal transmission fluid passage w extends through the travel independent valve V13 in the inlet block B. When the travel independent valve V13 is in the independent supply position 23, the PLS signal transmission fluid passage w is divided into a first line w1 extending from the travel independent valve V13 to the first SP control valve V1 and a second line w2 extending from the travel independent valve V13 to the second SP control valve V11. When the travel independent valve V13 is in the merging position 22, the first line w1 and the second line w2 are connected to each other.

The first line w1 transmits the load pressures on the first hydraulic actuators A1, and the second line w2 transmits the load pressures on the second hydraulic actuators A2.

Specifically, the first line w1 has connected thereto a plurality of first load transmission fluid passages y1 corresponding to the respective plurality of first hydraulic actuators A1 (including the hydraulic actuator C6, the swing cylinder C2, the arm cylinder C4, the swivel motor MT, the dozer cylinder C1, and the travel motor MR) and to transmit the respective loads on the respective first hydraulic actuators A1. The second line w2 has connected thereto a plurality of second load transmission fluid passages y2 corresponding to the respective plurality of the second hydraulic actuators A2 (including the travel motor ML, the dozer cylinder C1, the boom cylinder C3, the bucket cylinder C5, and the hydraulic actuator C7) and to transmit the respective loads on the respective second hydraulic actuators A2.

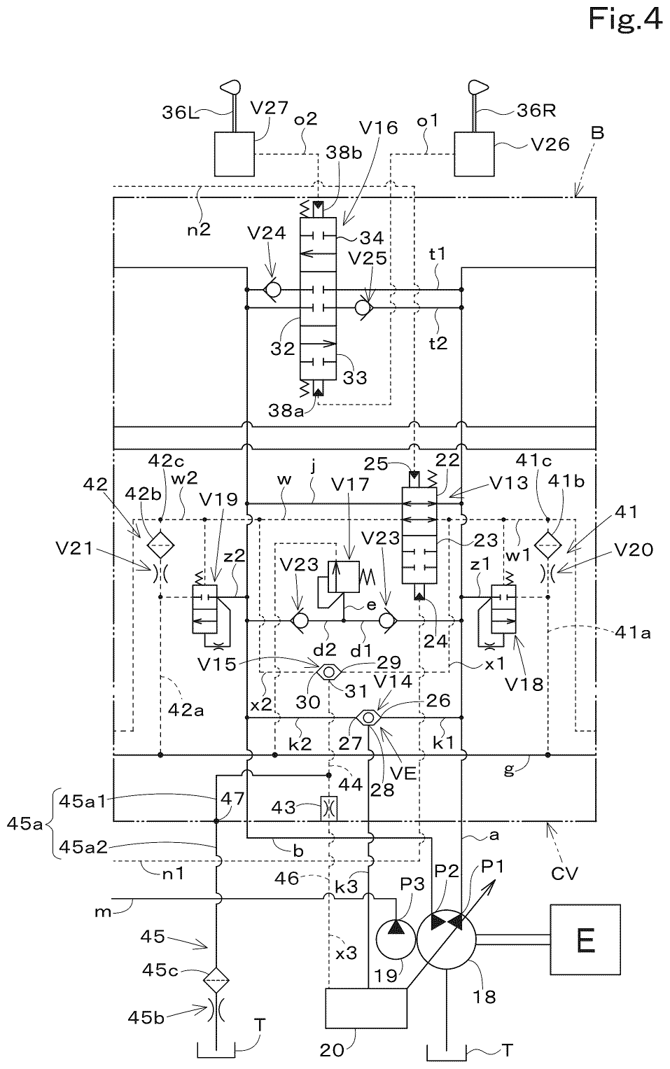

As shown in FIG. 4, one of input ports (input port 29) of the PLS signal shuttle valve (load pressure selection valve) V15 is connected to the first line w1 via a first PLS input fluid passage x1. The other of the input ports (input port 30) of the PLS signal shuttle valve (load pressure selection valve) V15 is connected to the second line w2 via a second PLS input fluid passage x2. An output port 31 of the PLS signal shuttle valve V15 is connected to the regulator 20 via a PLS output fluid passage x3.

Therefore, when the travel independent valve V13 is in the merging position 22, the highest one of the load pressures on the hydraulic actuators controlled respectively by the control valves V1 to V11 of the control valve assembly CV is transmitted from the open one of the input ports 29, 30 of the PLS signal shuttle valve V15 to the regulator 20.

When the travel independent valve V13 is in the independent supply position 23, (i) the higher one of the pressure in the first line w1 and the pressure in the second line w2 (the highest load pressure which is the higher one of the load pressure on the first hydraulic actuators A1 and the load pressure on the second hydraulic actuators A2) is transmitted to the regulator 20 or (ii) when the first line w1 and the second line w2 are subjected to the same pressure, the higher one of the pressure in the first line w1 and the pressure in the second line w2 is transmitted from the open one of the input ports 29, 30 of the signal shuttle valve V15 to the regulator 20.

The above-described PLS output fluid passage x3 is a load pressure transmission passage provided between the regulator 20 and the load pressure selection valve (PLS signal shuttle valve) V15. The PLS output fluid passage x3 is also referred to as a load pressure transmission passage.

A signal selection valve assembly VE includes the PPS signal shuttle valve V14 and the PLS signal shuttle valve V15. When the travel independent valve V13 is in the merging position 22, the signal selection valve assembly VE can transmit, to the regulator 20, (i) the highest load pressure which is the highest one of the load pressures on the hydraulic actuators MR, ML, MT, C1 to C7 and (ii) the delivery pressure of the main pump 18. When the travel independent valve V13 is in the independent supply position 23, the signal selection valve assembly VE can transmit, to the regulator 20, the higher one of the load pressure on the travel motor MR of the right traveling device 5 and the load pressure on the hydraulic motor ML of the left traveling device 5, and the higher one of the delivery pressure at the first outlet port P1 and the delivery pressure at the second outlet port P2.

The first unloading valve V18 is connected to the first delivery passage a via a first unloading fluid passage z1, and the second unloading valve V19 is connected to the second delivery passage b via a second unloading fluid passage z2.

The first unloading valve V18 and the second unloading valve V19 are each biased in the direction in which the valve is closed by the biasing force of one or more springs, as well as the pressure in the first line w1 acts on the first unloading valve V18 in the direction in which the valve is closed and the pressure in the second line w2 acts on the second unloading valve V19 in the direction in which the valve is closed.

As shown in FIGS. 3, 4, and 7, the travel bypass valve V16 is a direct-acting-spool-switching valve and is a pilot-operated switching valve switched by the pilot pressure. The travel bypass valve V16 is provided such that a first bypass fluid passage t1 and a second bypass fluid passage t2, connecting the first delivery passage a and the second delivery passage b in a parallel manner, extend through the travel bypass valve V16. In other words, the travel bypass valve V16 and the travel independent valve V13 are provided between the first delivery passage a and the second delivery passage b in a parallel manner.

The travel bypass valve V16 is switched between a blocking position (neutral position) 32 to block the pressure fluid from flowing through both the first bypass fluid passage t1 and the second bypass fluid passage t2, a first switching position 33 to allow pressure fluid to flow through the first bypass fluid passage t1 and block the pressure fluid from flowing through the second bypass fluid passage t2, and a second switching position 34 to block pressure fluid from flowing through the first bypass fluid passage t1 and allow pressure fluid to flow through the second bypass fluid passage t2.

The first bypass fluid passage t1 is provided with a check valve V24 to prevent the pressure fluid from flowing from the first delivery passage a to the second delivery passage b. The second bypass fluid passage t2 is provided with a check valve V25 to prevent the pressure fluid from flowing from the second delivery passage b to the first delivery passage a.

The travel bypass valve V16 is held in the blocking position 32 by one or more springs, the pilot pressure output from a right travel operating valve V26 operating the right travel control valve V6 acts in the direction in which the travel bypass valve V16 is switched from the blocking position 32 to the first switching position 33, and the pilot pressure output from a left travel operating valve V27 operating the left travel control valve V7 acts in the direction in which the travel bypass valve V16 is switched from the blocking position 32 to the second switching position 34.

When the pilot pressure of the right travel operating valve V26 and the pilot pressure of the left travel operating valve V27 have a difference in pressure equal to or more than a predetermined pressure, the higher one of the pilot pressures switches the travel bypass valve V16 from the blocking position 32 to the first switching position 33 or the second switching position 34.

The right travel operating valve V26 and the left travel operating valve V27 are controlled by operating a traveling lever 36R and a traveling lever 36L, respectively, and the pressure fluid is supplied from the sub-pump 19 to the travel operating valves V26, V27.

When each traveling lever 36R, 36L is operated in one of the forward and rearward directions, the pilot pressure in an instruction fluid passage q acts from the corresponding travel operating valve V26, V27 on one of pressure receivers (pressure receiver 37a) of the corresponding direction switching valve DV6, DV7 of the travel control valve V6, V7, and the direction switching valve DV6, DV7 is switched from the neutral position to one of the switching positions, allowing the pressure fluid to be supplied from one of a pair of pressure-fluid-supplying fluid passages u to a corresponding one of the trave motors ML, MR and the pressure fluid to be drained via the other of the pair of the pressure fluid supplying fluid passages u. On the other hand, when the traveling lever 36R, 36L is operated in the other of the forward and rearward directions, the pilot pressure in the instruction fluid passage q acts from the corresponding travel operating valve V26, V27 on the other of the pressure receivers (pressure receiver 37b) of the direction switching valve DV6, DV7 of the travel control valves V6, V7, and the direction switching valve DV6, DV7 is switched from the neutral position to the other of the switching positions, allowing the pressure fluid to be supplied from the other of the pair of the pressure-fluid-supplying fluid passages u to the corresponding one of the travel motors ML, MR, and the pressure fluid is drained via the one of the pressure-fluid-supplying fluid passages u. This drives the travel motors ML, MR in normal and reverse directions.

The pilot pressure in the instruction fluid passage q of the right travel operating valve V26 acts on one of pressure receivers (pressure receiver 38a) of the travel bypass valve V16 via a shuttle valve V28 and a first transmission fluid passage o1, and the pilot pressure in the instruction fluid passage q connected to the left travel operating valve V27 acts on the other of the pressure receivers (pressure receiver 38b) of the travel bypass valve V16 via a shuttle valve V29 and a second transmission fluid passage o2.

In the above-described hydraulic system, when the direction switching valves DV1 to DV11 of the control valves V1 to V11 are in the neutral position, the travel independent valve V13 is in the merging position 22. In so doing, the first unloading fluid passage z1 connected to the first delivery passage a is blocked by the first unloading valve V18, and the second unloading fluid passage z2 connected to the second delivery passage b is blocked by the second unloading valve V19. Therefore, when the delivery pressure (PPS signal pressure) of the main pump 18 increases and the difference between the PPS signal pressure and the PLS signal pressure (at the time, zero) is greater than a control pressure difference, the main pump 18 is controlled regarding the flow rate to reduce the delivery rate of the delivery fluid, and the delivery fluid delivered by the main pump 18 is drained to the hydraulic fluid tank T by the first unloading valve V18 and the second unloading valve V19 opening.

In this state, the delivery pressure in the first delivery passage a and the second delivery passage b of the main pump 18 is determined by the first unloading valve V18 and the second unloading valve V19, and the flow rate of the delivery fluid delivered by the main pump 18 corresponds to the minimum delivery rate.

The following discusses the case where one or more of the first SP control valve V1, the swing control valve V2, the arm control valve V3, the swivel control valve V4, the boom control valve V9, the bucket control valve V10, and the second SP control valve V11 are operated without driving the traveling devices 5 or the dozer device 7, or where (i) one or more of the first SP control valve V1, the swing control valve V2, the arm control valve V3, the swivel control valve V4, the boom control valve V9, the bucket control valve V10, and the second SP control valve V11, and (ii) one or more of the right travel control valve V6, the left travel control valve V7, the first dozer control valve V5 and the second dozer control valve V8, are operated concurrently.

In this case, the travel independent valve V13 is in the merging position 22, the pressure in the first delivery passage a and the second delivery passage b is transmitted as the PPS signal pressure to the regulator 20 via the PPS signal shuttle valve V14, and the highest one of the load pressure(s) acting on the operated one(s) of the hydraulic actuators ML, MR, MT, C1 to C7 is transmitted as the PLS signal pressure to the regulator 20 via the PLS signal shuttle valve V15.

The delivery pressure of (flow rate of the delivery fluid delivered by) the main pump 18 is automatically controlled such that the difference obtained by subtracting the PLS signal pressure from the PPS signal pressure is equal to a control pressure difference (such that the difference between the PPS signal pressure and the PLS signal pressure is maintained at a predetermined value).

That is, when the unload flow rate of the delivery fluid via the first unloading valve V18 and the second unloading valve V19 is zero, the flow rate of the fluid delivered by the main pump 18 starts increasing, and the fluid delivered by the main pump 18 entirely flows to the operated one(s) of the hydraulic actuators ML, MR, MT, C1 to C7 according to the operation amount of the corresponding operated one(s) of the control valves V1 to V11.

The pressure compensation valve V12 makes constant the difference in pressure between upstream and downstream sides of the spool of the corresponding direction switching valve DV1 to DV11 of the corresponding operated control valve V1 to V11, and the flow rate of the delivery fluid delivered by the main pump 18 is distributed according to the operation amounts with respect to the operated hydraulic actuators ML, MR, MT, C1 to C7, regardless of the difference in the amount of load acting on the operated hydraulic actuators ML, MR, MT, C1 to C7.

When the flow rate of the delivery fluid required by the hydraulic actuators ML, MR, MT, C1 to C7 is greater than the maximum flow rate of the delivery fluid delivered by the main pump 18, the delivery fluid delivered by the main pump 18 is proportionally distributed toto the operated hydraulic actuators ML, MR, MT, C1 to C7.

In this case, even if the travel bypass valve V16 is switched to the first switching position 33 or the second switching position 34, there is no problem since the delivery fluid delivered by the main pump 18 through the first delivery passage a and the second delivery passage b are merged.

In the hydraulic system of the present example embodiment, when the traveling devices 5 and the front working device 11 are operated in a combined manner, the merged fluid delivered by the main pump 18 through first outlet port P1 and the second outlet port P2 drives the traveling devices 5 and the front working device 11, and the flow rate of the delivery fluid delivered by the main pump 18 is controlled during the combined operation of the traveling devices 5 and the front working device 11, making it possible to operate, concurrently (in a combined manner), the traveling devices 5 and the front working device 11 with the efficient system, and possible to achieve the working machine performance and save energy (low fuel consumption, heat balance) at a higher level.

Even during the combined operation of the front working device 11 and the traveling devices 5, there is no insufficiency in speed (in sufficiency in flow rate) of the front working device 11.

The following discusses the case where one or more of the right travel control valve V6, left travel control valve V7, the first dozer control valve V5, and the second dozer control valve V8 are operated without operating the first SP control valve V1, the swing control valve V2, the arm control valve V3, the swivel control valve V4, the boom control valve V9, the bucket control valve V10, or the second SP control valve V11.

In this case, the travel independent valve V13 is switched to the independent supply position 23, the travel independent valve V13 blocks the communication passage j and the PLS signal transmission fluid passage w, the pressure fluid output from the first outlet port P1 flows to the right travel control valve V6 and the first dozer control valve V5, the pressure fluid output from the second outlet port P2 flows to the left travel control valve V7 and the second dozer control valve V8, and the PLS signal transmission fluid passage w is divided into the first line w1 and the second line w2.

The higher one of the pressure in the first delivery passage a and the pressure in the second delivery passage b is transmitted as the PPS signal pressure to the regulator 20 via the PPS signal shuttle valve V14 (in the case where the first delivery passage a and the second delivery passage b are subjected to the same pressure, the pressure is transmitted from the open one of the input ports 26, 27 of the PPS signal shuttle valve V14 to the regulator 20). The higher one of the pressure in the first line w1 and the pressure in the second line w2 is transmitted as the PLS signal pressure to the regulator 20 via the PLS signal shuttle valve V15 (in the case where the first line w1 and the second line w2 are subjected to the same pressure, the pressure is transmitted from the open one of the input ports 29, 30 of the PLS signal shuttle valves V15 to the regulator 20).

Also in the above case, the delivery pressure of (flow rate of the delivery fluid delivered by) the main pump 18 is automatically controlled such that the difference obtained by subtracting the PLS signal pressure from the PPS signal pressure is equal to the control pressure difference (such that the difference between the PPS signal pressure and the PLS signal pressure is maintained at the predetermined value).

In the hydraulic system of the present example embodiment, the first dozer control valve V5 and the second dozer control valve V8 suck the pressure fluid equally from the first delivery passage a and the second delivery passage b and deliver the pressure fluid to the dozer cylinder C1, making it possible to ensure that the backhoe 1 travels straight, and possible to save energy because the flow rate of the delivery fluid delivered by the main pump 18 is controlled according to the operation amount of each of the control valves V5, V6, V7, V8.

When the backhoe 1 turns left or right, since the pressure compensation valves V12 perform flow rate distribution control, even if the loads on the respective travel motors ML, MR are high and the load on the dozer cylinder C1 is low, the pressure fluid at a flow rate more than a predetermined flow rate does not flow to the dozer cylinder C1, making it possible to maintain an independent circuit configuration in which the pressure fluid from the first outlet port P1 is independently supplied to the right travel control valve V6 and the pressure fluid from the second outlet port P2 is independently supplied to the left travel control valve V7, and possible to suck the pressure fluid equally from the first outlet port P1 and the second outlet port P2, thus ensuring the flow rate of the pressure fluid supplied to the left travel motor ML and the right travel motor MR and ensuring turning performance.

In the above case, for example, a left turn is to be made on a flatland, when the right travel control valve V6 is operated such that the rotation of the right hydraulic motor MR of the traveling device 5 increases, the load pressure on the right hydraulic motor MR of the traveling device 5 increases higher than the load pressure on the left hydraulic motor ML of the traveling device 5, and the pressure of the hydraulic fluid delivered to the right hydraulic motor MR of the traveling device 5 is higher than the pressure of the hydraulic fluid delivered to the left hydraulic motor ML of the traveling device 5. It follows that load pressure (PLS signal pressure) on the right hydraulic motor MR of the traveling device 5 is transmitted to the regulator 20 via the PLS signal shuttle valve V15, the pressure (PPS signal pressure) in the first delivery passage a transmitted to the hydraulic motor MR of the right traveling device 5 is transmitted to the regulator 20, and the flow rate of the delivery fluid delivered by the main pump 18 is controlled based on the PLS signal pressure and the PPS signal pressure, making it possible for the backhoe 1 to turn left favorably. (On the other hand, when a right turn is to be made, the load pressure on the left hydraulic motor ML is transmitted to the regulator 20 via the PLS signal shuttle valve V15, the pressure in the second delivery passage b transmitted to the left hydraulic motor ML is transmitted to the regulator 20, and the flow rate of the delivery fluid delivered by the main pump 18 is controlled based on the PLS signal pressure and the PPS signal pressure.)

However, for example, when a left turn is to be made during forward travel in a downward slope, although the right travel control valve V6 is operated to increase the rotation of the right hydraulic motor MR of the traveling device 5, the backhoe's own weight acts on a direction of travel in the downward slope, and therefore the load pressure is not generated on the right hydraulic motor MR of the traveling device 5.

On the other hand, the pressure in the second delivery passage b to be transmitted to the left travel control valve V7 increases to the unload pressure, and therefore the pressure in the second delivery passage b to be transmitted to the left travel control valve V7 is transmitted as the PPS signal pressure to the regulator 20.

Therefore, in the case where the load pressure is not generated on the right hydraulic motor MR of the traveling device 5, the difference between the PLS signal pressure and the PPS signal pressure is in the state of surplus, and the flow rate of the delivery fluid delivered by the main pump 18 does not increase, making impossible for the backhoe 1 to turn.

However, in the present example embodiment, in this case, since the pilot pressure output from the right travel operating valve V26 is higher than the pilot pressure output from the left travel operating valve V27, the travel bypass valve V16 is switched to the first switching position 33, and the delivery fluid from the second outlet port P2 flows from the second delivery passage b to the first delivery passage a via the first bypass fluid passage t1 (On the other hand, when a right turn is to be made, the travel bypass valve V16 is switched to the second switching position 34, and the delivery fluid from the first outlet port P1 flows from the first delivery passage a to the second delivery passage b via the second bypass fluid passage t2).

With this, the system in which the pressure fluid is supplied to the right hydraulic motor MR of the traveling device 5 is kept at high pressure, making it possible to control the flow rate of the delivery fluid delivered by the main pump 18 based on the PLS signal pressure and the PPS signal pressure from the right side, and possible to achieve a turn on a downward slope favorably.

When a left turn is to be made on a flatland, even if the travel bypass valve V16 is switched to the first switching position 33, the pressure fluid does not flow from the first delivery passage a to the second delivery passage b via the first bypass fluid passage t1 because of the check valve V24. (When a right turn is to be made, even if the travel bypass valve V16 is switched to the second switching position 34, the pressure fluid does not flow from the second delivery passage b to the first delivery passage a via the second bypass fluid passage t2.) Therefore, there is no problem when the backhoe 1 turns on a flatland.

In the case where the left travel operating valve V26 and the right travel operating valve V27 are subjected to the same pilot pressure, the travel bypass valve V16 is in the blocking position 32, and the pressure fluid does not flow between the first delivery passage a and the second delivery passage b of the main pump 18, making it possible to ensure straight travel.

As shown in FIG. 4, the first end of the first release path 41 is in fluid communication with the first line w1 and the second end of the first release path 41 is in fluid communication with the drain fluid passage (tank path) g, so that a portion of the hydraulic fluid in the first line w1 is allowed to escape to the hydraulic fluid tank T through the drain fluid passage g. Specifically, the first release path 41 includes a first release flow passage 41a, a first release throttle V20, and an oil filter. A first end of the first release flow passage 41a is connected to the first line w1 at a location downstream of the junction with the first load transmission fluid passage y1 to transmit the load pressure on the travel motor MR, and a second end of the first release flow passage 41a is connected to the drain fluid passage g. The first release throttle V20 is provided in the first release flow passage 41a and restricts the flow of the hydraulic fluid. The oil filter 41b is provided at a location upstream of the first release throttle V20 in the first release flow passage 41a.

The first release path 41 is configured to release the pressure in the first line w1 when the operations of all the first hydraulic actuators A1 (hydraulic actuator C6, the swing cylinder C2, the arm cylinder C4, the swivel motor MT, the dozer cylinder C1, and the travel motor MR) are stopped (when all the first SP control valve V1, the swing control valve V2, the arm control valve V3, the swivel control valve V4, the first dozer control valve V5, and the right travel control valve V6 are in the neutral position).

A first end of the second release path 42 is in fluid communication with the second line w2, and a second end of the second release path 42 is in fluid communication with the drain fluid passage g, so that a portion of the hydraulic fluid in the second line w2 is allowed to escape to the hydraulic fluid tank T through the drain fluid passage g. Specifically, the second release path 42 includes a second release flow passage 42a, a second release throttle V21, and an oil filter 42b. A first end of the second release flow passage 42a is connected to the second line w2 at a location downstream of the junction with the second load transmission fluid passage y2 to transmit the load pressure on the travel motor ML, and a second end of the second release flow passage 42a is connected to the drain fluid passage g. The second release throttle V21 is provided in the second release flow passage 42a and restricts the flow of the hydraulic fluid. The oil filter 42b is provided at a location upstream of the second release throttle V21 in the second release flow passage 42a.

The second release path 42 is configured to release the pressure in the second line w2 when the operations of all the second hydraulic actuators A2 (the travel motor ML, the dozer cylinder C1, the boom cylinder C3, the bucket cylinder C5, and the hydraulic actuator C7) are stopped (when all of the left travel control valve V7, the second dozer control valve V8, the boom control valve V9, the bucket control valve V10, and the second SP control valve V11 are in the neutral position).

As shown in FIGS. 2, 3, and 4, the hydraulic system of the present example embodiment includes a passage throttle 43 provided in the load pressure transmission passage x3 located between the regulator 20 and the load pressure selection valve V15 and configured to control the responsiveness of the regulator 20. The passage throttle 43 is, in the present example embodiment, provided in the inlet block B of the control valve assembly CV. This does not imply any limitation.

The hydraulic system includes a bleed path 45 to allow a portion of the hydraulic fluid in the segment passage 44 of the load pressure transmission passage x3 that extends between the load pressure selection valve V15 and the passage throttle 43 to leak (bleed a portion of the hydraulic fluid to a destination other than the regulator 20 (to the hydraulic fluid tank T)). Specifically, the bleed path 45 includes a bleed passage 45a, a bleed throttle 45b, and an oil filter 45c. The bleed passage 45a includes a first bleed passage 45a1 which is provided in the control valve assembly CV and which includes a first end connected to the segment passage 44, and a second bleed passage 45a2 including a first end connected to a second end of the first bleed passage 45a1 and a second end in fluid communication with the hydraulic fluid tank T. In the present example embodiment, as shown in FIG. 4, the first end of the first bleed passage 45a1 is connected to a portion of the segment passage 44 that is at a location upstream of and in the vicinity of the passage throttle 43. The second end of the first bleed passage 45a1 is connected to a drain port 47 provided in the control valve assembly CV. The first end of the second bleed passage 45a2 is connected to the drain port 47. The bleed throttle 45b is provided in the second bleed passage 45a2 and restricts a flow of the hydraulic fluid. The oil filter 45c is provided at a location upstream of the bleed throttle 45b in the second bleed passage 45a2.

The bleed throttle 45b and the oil filter 45c may be configured such that a bushing or the like including one or both of the bleed throttle 45b and the oil filter 45c is attached to the control valve assembly CV. Alternatively, one or both of the bleed throttle 45b and the oil filter 45c may be attached directly to the control valve assembly CV. One or both of the bleed throttle 45b and the oil filter 45c may be provided in the first bleed passage 45a1. The bleed throttle 45b may be provided in the control valve assembly CV such that the hydraulic fluid having passed the bleed throttle 45b is drained to the hydraulic fluid tank T via the drain fluid passage (tank passage) g provided in the control valve assembly CV. Specifically, the segment passage 44 and the drain fluid passage g may be connected by the bleed passage 45a in the control valve assembly CV and the bleed throttle 45b may be provided in the bleed passage 45a. With this, the exhaust pressure in the drain fluid passage g acts to further stabilize the flow rate of the hydraulic fluid passing through the bleed throttle 45b.

The working machine 1 includes a pump assembly including the main pump 18 and the sub-pump 19. The pump assembly is attached to the prime mover E. The regulator 20 is provided in the pump assembly. The control valve assembly CV is provided in or on the swivel base 10, for example, at the front portion of the swivel base 10. In the load pressure transmission passage x3, the control valve assembly CV and the regulator 20 are connected by a hydraulic hose 46 downstream of the control valve assembly CV (downstream of the passage throttle 43) (see FIG. 4).

In the case where no passage throttle 43 is provided, the hydraulic hose 46 would expand when the load pressure output from the load pressure selection valve V15 enters the hydraulic hose 46. In the present embodiment, however, the passage throttle 43 is provided in the load pressure transmission passage x3 to deal with the expansion of the hydraulic hose 46. That is, the elastic hydraulic hose 46 is elastic and expands when the pressure enters, but the effect of the passage throttle 43 acts on the amount of the passing hydraulic fluid that increases as the hydraulic hose 46 expands, thus slowing the responsiveness and stabilizing the responsiveness.

Note, however, that in the related art, when the viscosity of the hydraulic fluid increases as the temperature lowers, the response delays because the passage throttle 43 hinders the transmission of the load pressure. Furthermore, the load pressure selection valve V15 functions as a resistance. In the related art, after the hydraulic fluid passes through the junction 41c (see FIG. 3) of the first release path 41 in the first line w1 and the junction 42c (see FIG. 3) of the second release path 42 in the second line w2 (at a location downstream of the junction 41c of the first release path 41 and at a location downstream of the junction 42c of the second release path 42), a flow of the hydraulic fluid almost does not occur, and therefore, when the viscosity of the hydraulic fluid increases at low temperature, the response delays also because of the load pressure selection valve V15.

It is noted that, once the response has delayed by a given amount, the phase may be reversed and so-called periodic hunting may occur.

In the working machine 1 of the present example embodiment, when the load pressure is output from the load pressure selection valve V15, the bleed path 45 allows a portion of the hydraulic fluid in the segment passage 44 provided between the load pressure selection valve V15 and the passage throttle 43 to flow to the hydraulic fluid tank T (allows a portion of the hydraulic fluid to leak to the hydraulic fluid tank T). With this, it is possible to warm up the passage throttle 43 and the load pressure selection valve V15. Specifically, the flow of the hydraulic fluid is generated in the segment passage 44 between the load pressure selection valve V15 and the passage throttle 43 by the bleed path 45 allowing a portion of the hydraulic fluid in the segment passage 44 to leak (bleeding a portion of the hydraulic fluid to a destination other than the regulator 20 (to the hydraulic fluid tank T)), making it possible to improve the warming-up performance of the passage throttle 43. Furthermore, the flow of the hydraulic fluid is also generated in the load pressure selection valve V15 by the bleed path 45 allowing the hydraulic fluid to leak, making it possible to improve the warming-up performance of the load pressure selection valve V15. With this, it is possible to improve responsiveness at low temperature.

Note that, for example, although a portion of the hydraulic fluid may be allowed to flow to the hydraulic fluid tank T at a location downstream of the passage throttle 43 (for example, a throttle may be provided inside the regulator 20 to allow a portion of the hydraulic fluid to flow to the hydraulic fluid tank T via the throttle), in such a case, the flow of the hydraulic fluid is generated at the passage throttle 43 by allowing a portion of the hydraulic fluid to flow to the hydraulic fluid tank T via the throttle, and therefore a pressure loss may occur, resulting in a reduction in speed of the hydraulic actuators (a reduction in responsiveness of the hydraulic actuators).

In the present example embodiment, the bleed path 45 allows a portion of the hydraulic fluid to flow to the hydraulic fluid tank T at a location upstream of the passage throttle 43. Therefore, the passage throttle 43 is not subjected to a pressure loss that would otherwise occur because a portion of the hydraulic fluid is allowed to flow to the hydraulic fluid tank T, and this does not cause a reduction in speed of the hydraulic actuators and in responsiveness that would otherwise occur because of the bleed path 45.

An example of a method to transmit the highest load pressure which is the highest one of the load pressures on the respective plurality of hydraulic actuators to the regulator 20 is a multistage shuttle valve method to compare every two load pressures sequentially to finally obtain the highest load pressure. The multistage shuttle valve method is as follows. First, the higher one of the load pressure on a first hydraulic actuator and the load pressure on a second hydraulic actuator of a plurality of hydraulic actuators is selected as a first load pressure by a first shuttle valve, the higher one of the selected first load pressure and the load pressure on a third hydraulic actuator which is another hydraulic actuator is selected as a second load pressure by a second shuttle valve, the higher one of the selected second load pressure and the load pressure on a fourth hydraulic actuator which is another hydraulic actuator is selected as a third load pressure by a third shuttle valve, and such load pressure selection steps are performed sequentially to finally obtain the highest load pressure.

In the hydraulic system to obtain the highest load pressure using the above-described multistage shuttle valve method, for example, when a portion of the hydraulic fluid at a location upstream of the passage throttle 43 is allowed to leak to the hydraulic fluid tank T, shuttle valves are each subjected to a pressure loss, and this causes a reduction in speed and responsiveness of the hydraulic actuators.

The present example embodiment uses a method in which the load pressure selection valve V15 receives input of the load pressures on the first hydraulic actuators and the load pressures on the second hydraulic actuators, and outputs the highest load pressure which is the higher one of the load pressure on the first hydraulic actuators and the load pressure on the second hydraulic actuators. In other words, the present example embodiment uses a method in which the first release path 41 is connected to the first line w1 to transmit the load pressures on the first hydraulic actuators, the second release path 42 is connected to the second line w2 to transmit the load pressures on the second hydraulic actuators, and the load pressure selection valve V15 outputs the highest load pressure of the load pressures on the first hydraulic actuators and the load pressures on the second hydraulic actuators at a location downstream of the junction of the first release path 41 and the first line w1 and at a location downstream of the junction of the second release path 42 and the second line w2. Therefore, only a single shuttle valve is provided in the load signal pressure transmission circuit (PLS signal pressure transmission circuit) to transmit the highest load pressure on the hydraulic actuators to the regulator 20. Even though the bleed path 45 is connected to the passage (segment passage 44) at a location downstream of the load pressure selection valve V15 such that the bleed path 45 allows a portion of the hydraulic fluid to leak to the hydraulic fluid tank T, it is possible to improve the warming-up performance with a pressure loss only in a single load pressure selection valve V15.

As described above, in the present example embodiment, the bleed path 45 is provided to allow a portion of the hydraulic fluid in the segment passage 44 located between the load pressure selection valve V15 and the passage throttle 43 to leak (bleed a portion of the hydraulic fluid to a destination other than the regulator 20 (to the hydraulic fluid tank T)), making it possible to improve warming-up performance with a pressure loss only in a single load pressure selection valve V15 (shuttle valve), without a pressure loss in the passage throttle 43. In other words, it is possible to minimize the reduction in speed resulting from the pressure loss in some portions of the PLS signal pressure transmission circuit, and possible to obtain sufficient warming-up performance.

Example embodiments of the present invention provide working machines 1 described in the following items.

(Item 1) A working machine 1 including a first outlet port P1 and a second outlet port P2 to allow hydraulic fluid to flow out therefrom, a plurality of first hydraulic actuators A1 to be supplied with hydraulic fluid from the first outlet port P1, a plurality of second hydraulic actuators A2 to be supplied with hydraulic fluid from the second outlet port P2, a load pressure selection valve V15 to receive input of a load pressure on the plurality of first hydraulic actuators A1 and a load pressure on the plurality of second hydraulic actuators A2, and output a highest load pressure which is a higher one of the load pressure on the plurality of first hydraulic actuators A1 and the load pressure on the plurality of second hydraulic actuators A2, a regulator 20 to receive input of the highest load pressure output from the load pressure selection valve V15, and control a discharge rate of the hydraulic fluid from the first outlet port P1 and a discharge rate of the hydraulic fluid from the second outlet port P2 according to the input highest load pressure, a passage throttle 43 provided in a load pressure transmission passage x3 provided between the regulator 20 and the load pressure selection valve V15, and a bleed path 45 to allow a portion of the hydraulic fluid in a segment passage 44 to escape to a destination other than the regulator 20, the segment passage being a portion of the load pressure transmission passage x3 that is located between the load pressure selection valve V15 and the passage throttle 43.

With the working machine 1 according to item 1, a flow of the hydraulic fluid is generated in the segment passage 44 provided between the load pressure selection valve V15 and the passage throttle 43 caused by the bleed path 45 allowing a portion of the hydraulic fluid in the segment passage 44 to escape to a destination other than the regulator 20, making it possible to improve the warming-up performance of the passage throttle 43. Furthermore, a flow of the hydraulic fluid is generated also in the load pressure selection valve V15 caused by the bleed path 45 allowing a portion of the hydraulic fluid to escape to a destination other than the regulator 20, making it possible to improve the warming-up performance of the load pressure selection valve V15. With this, it is possible to improve responsiveness (responsiveness to transmit load pressure) at low temperature.

(Item 2) The working machine 1 according to item 1, further including a hydraulic fluid tank T to store the hydraulic fluid, wherein the bleed path 45 includes a bleed passage 45a including a first end connected to the segment passage 44 and a second end in fluid communication with the hydraulic fluid tank T, and a bleed throttle 45b provided in the bleed passage 45a.

With the working machine 1 according to item 2, it is possible to easily establish the bleed path 45 to allow a portion of the hydraulic fluid in the segment passage 44 to escape to a destination other than the regulator 20.

(Item 3) The working machine 1 according to item 2, wherein the first end of the bleed passage 45a is connected to a portion of the segment passage 44 that is in a vicinity of the passage throttle 43.

With the working machine 1 according to item 3, it is possible to improve the warming-up performance of the passage throttle 43 efficiently. For example, in the case where a portion of the hydraulic fluid is allowed to flow to the hydraulic fluid tank T at a location downstream of the passage throttle 43, a flow of the hydraulic fluid is generated in the passage throttle 43 by allowing the hydraulic fluid to leak, and a pressure loss is caused thereby in the passage throttle 43, causing an adverse effect on the speed (responsiveness) of the hydraulic actuators. However, in the present example embodiment, since the bleed path 45 allows a portion of the hydraulic fluid to flow to the hydraulic fluid tank T at a location upstream of the passage throttle 43, the passage throttle 43 is not subjected to a pressure loss caused by allowing a portion of the hydraulic fluid to flow to the hydraulic fluid tank T, making it possible to eliminate or reduce the likelihood that a reduction in speed and responsiveness of the hydraulic actuators will occur by the passage throttle 43 being subjected to a pressure loss because of the bleed path 45.

(Item 4) The working machine 1 according to any one of items 1 to 3, further including a hydraulic fluid tank T to store the hydraulic fluid, a first line w1 connected to one of input ports 29 of the load pressure selection valve V15, a second line w2 connected to another of the input ports 30 of the load pressure selection valve V15, a plurality of first load transmission fluid passages y1 which are connected to the first line w1 and which correspond to the respective plurality of first hydraulic actuators A1 to transmit respective loads on the respective plurality of first hydraulic actuators A1, and, a plurality of second load transmission fluid passages y2 which are connected to the second line w2 and which correspond to the respective plurality of second hydraulic actuators A2, to transmit respective loads on the respective plurality of second hydraulic actuators A2, a first release path 41 to allow a portion of the hydraulic fluid in the first line w1 to escape to the hydraulic fluid tank T at a location upstream of the load pressure selection valve V15, and a second release path 42 to allow a portion of the hydraulic fluid in the second line w2 to escape to the hydraulic fluid tank T at another location upstream of the load pressure selection valve V15.

With the working machine 1 according to item 4, the first release path 41 is provided to allow, at a location upstream of the load pressure selection valve V15, a portion of the hydraulic fluid to escape from the first line w1 which transmits the load pressures on the first hydraulic actuators A1, and the second release path 42 is provided to allow, at a location upstream of the load pressure selection valve V15, a portion of the hydraulic fluid to escape from the second line w2 which transmits the load pressures on the second hydraulic actuators A2, and the load pressure selection valve V15 outputs the highest one of the load pressures on the first hydraulic actuators A1 and the load pressures on the second hydraulic actuators A2 at a location downstream of a junction 41c of the first line w1 and the first release path 41 and at a location downstream of a junction 42c of the second line w2 and the second release path 42. Therefore, only a single shuttle valve is provided in the load signal transmission circuit to transmit the highest load pressure selected from the load pressures on the operated one(s) of The hydraulic actuators A1, A2 as the load signal pressure to the regulator 20 and, even though the bleed path 45 is connected at a location downstream of the load pressure selection valve V15 and the bleed path 45 allows a portion of the hydraulic fluid to escape to a destination other than the regulator 20 (for example, leaked to the hydraulic fluid tank T), it is possible to improve warming-up performance with the effect of a pressure loss only in a single load pressure selection valve V15.

(Item 5) The working machine 1 according to any one of items 1 to 3, further including a plurality of first control valves VA1, which correspond to the respective plurality of first hydraulic actuators A1, to control a flow of the hydraulic fluid with respect to the respective plurality of first hydraulic actuators A1, a plurality of second control valves VA2, which correspond to the respective plurality of second hydraulic actuators A2, to control a flow of the hydraulic fluid with respect to the respective plurality of second hydraulic actuators A2, and a control valve assembly CV including the plurality of first control valves VA1, the plurality of second control valves VA2, the load pressure selection valve V15, and the passage throttle 43, wherein a portion of the load pressure transmission passage x3 that is between the control valve assembly CV and the regulator 20 includes a hydraulic hose 46.

In the case where no passage throttle 43 is provided, when the load pressure output from the load pressure selection valve V15 enters the hydraulic hose 46, the hydraulic hoses 46 expands, and this increases the amount of the passing hydraulic fluid and places an adverse effect on the stability of responsiveness. However, in the example embodiment according to item 5, the passage throttle 43 is provided to restrict the flow rate of the hydraulic fluid, and acts on the amount of flowing hydraulic fluid increased by the expansion of the hydraulic hoses 46 to slow the responsiveness, making it possible to stabilize the responsiveness. Furthermore, even though the passage throttle 43 is provided, since the bleed path 45 generates a flow of the hydraulic fluid by allowing a portion of the hydraulic fluid to leak, it is possible to prevent or reduce a reduction in responsiveness at low temperature.

(Item 6) The working machine 1 according to item 5 taken in combination with item 2 or 3, wherein the bleed throttle 45b is directly or indirectly attached to the control valve assembly CV.

(Item 7) The working machine 1 according to item 5 taken in combination with item 2 or 3, wherein the bleed passage 45a is included in the control valve assembly CV, the first end of the bleed passage 45a is connected to the segment passage 44, and the second end of the bleed passage 45a is in fluid communication with the hydraulic fluid tank T via a drain fluid passage g provided in the control valve assembly CV.

With the working machine 1 according to item 7, the pressure of hydraulic fluid from the drain fluid passage g acts, making it possible to further stabilize the flow rate of the hydraulic fluid flowing through the bleed throttle 45b.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working machine comprising:
a first outlet port and a second outlet port to allow hydraulic fluid to flow out therefrom;
a plurality of first hydraulic actuators to be supplied with hydraulic fluid from the first outlet port;
a plurality of second hydraulic actuators to be supplied with hydraulic fluid from the second outlet port;
a load pressure selection valve to:
receive input of a load pressure on the plurality of first hydraulic actuators and a load pressure on the plurality of second hydraulic actuators, and
output a highest load pressure which is a higher one of the load pressure on the plurality of first hydraulic actuators and the load pressure on the plurality of second hydraulic actuators;
a regulator to:
receive input of the highest load pressure output from the load pressure selection valve, and
control a discharge rate of the hydraulic fluid from the first outlet port and a discharge rate of the hydraulic fluid from the second outlet port according to the input highest load pressure;
a passage throttle provided in a load pressure transmission passage provided between the regulator and the load pressure selection valve; and
a bleed path to allow a portion of the hydraulic fluid in a segment passage to escape to a destination other than the regulator, the segment passage being a portion of the load pressure transmission passage that is located between the load pressure selection valve and the passage throttle.

2. The working machine according to claim 1, further comprising a hydraulic fluid tank to store the hydraulic fluid; wherein
the bleed path includes:
a bleed passage including a first end connected to the segment passage and a second end in fluid communication with the hydraulic fluid tank; and
a bleed throttle provided in the bleed passage.

3. The working machine according to claim 2, wherein
the first end of the bleed passage is connected to a portion of the segment passage that is in a vicinity of the passage throttle.

4. The working machine according to claim 1, further comprising:
a hydraulic fluid tank to store the hydraulic fluid;
a first line connected to one of input ports of the load pressure selection valve;
a second line connected to another of the input ports of the load pressure selection valve;
a plurality of first load transmission fluid passages which are connected to the first line and which correspond to the respective plurality of first hydraulic actuators to transmit respective loads on the respective plurality of first hydraulic actuators; and
a plurality of second load transmission fluid passages which are connected to the second line and which correspond to the respective plurality of second hydraulic actuators to transmit respective loads on the respective plurality of second hydraulic actuators;
a first release path to allow a portion of the hydraulic fluid in the first line to escape to the hydraulic fluid tank at a location upstream of the load pressure selection valve; and
a second release path to allow a portion of the hydraulic fluid in the second line to escape to the hydraulic fluid tank at another location upstream of the load pressure selection valve.

5. The working machine according to claim 1, further comprising:
a plurality of first control valves, which correspond to the respective plurality of first hydraulic actuators, to control a flow of the hydraulic fluid with respect to the respective plurality of first hydraulic actuators;
a plurality of second control valves, which correspond to the respective plurality of second hydraulic actuators, to control a flow of the hydraulic fluid with respect to the respective plurality of second hydraulic actuators; and
a control valve assembly including the plurality of first control valves, the plurality of second control valves, the load pressure selection valve, and the passage throttle; wherein
a portion of the load pressure transmission passage that is between the control valve assembly and the regulator includes a hydraulic hose.

6. The working machine according to claim 5, further comprising a hydraulic fluid tank to store the hydraulic fluid; wherein
the bleed path includes:
a bleed passage including a first end connected to the segment passage and a second end in fluid communication with the hydraulic fluid tank; and
a bleed throttle provided in the bleed passage; and
the bleed throttle is directly or indirectly attached to the control valve assembly.

7. The working machine according to claim 5, further comprising a hydraulic fluid tank to store the hydraulic fluid; wherein
the bleed path includes:
a bleed passage including a first end connected to the segment passage and a second end in fluid communication with the hydraulic fluid tank; and
a bleed throttle provided in the bleed passage; and
the bleed passage is included in the control valve assembly, the first end of the bleed passage is connected to the segment passage, and the second end of the bleed passage is in fluid communication with the hydraulic fluid tank via a drain fluid passage provided in the control valve assembly.
